(19) United States
(12) Patent Application Publication
(10) Pub. No.: US 2010/0174462 A1
(43) Pub. Date: Jul. 8, 2010

(54) MANUALLY SHIFTABLE MULTISTEP TRANSMISSION FOR MOTOR VEHICLES

(75) Inventor: Gianmaria Pigozzi, Brescia (IT)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/601,537

(22) PCT Filed: Apr. 28, 2008
(86) PCT No.: PCT/EP2008/055132

§ 371 Date: Nov. 24, 2009

(30) Foreign Application Priority Data
May 26, 2007 (DE) 10 2007 024 793.3

(51) Int. Cl. F16H 61/70; G06F 19/00

(52) U.S. Cl. 701/55

(57) ABSTRACT

A manually shifted multi-step transmission for motor vehicle having a main transmission and a group transmission embodied as a range group. The shifting of the gears occurs according to a “simple H-shaped shift pattern” by way of a manual shift lever which is moved in shift gates or in a selector gate, and the range group can be shifted into a “high” range stage and into a “low range stage”. The range group can be shifted automatically by way of a control device having a rotational speed sensor which detects the transmission output rotational speed, and a sensor which detects the shift gate of the gear to be shifted.

This application is a National Stage completion of PCT/EP2008/055132 filed Apr. 28, 2008, which claims priority of German patent application serial no. 10 2007 024 793.3 filed May 26, 2007.

### FIELD OF THE INVENTION

The invention relates to a manually shiftable multistep transmission for motor vehicles, a method for automatically shifting stages of a range group as well as a device for performing the method.

### BACKGROUND OF THE INVENTION

It is known, e.g. from G. Lechner, H. Naunheimer, Fahrzeuggetriebe (Vehicle Transmissions), 1994, pp. 149-158 or J. Looman, Zahnradgetriebe (Gear Transmissions), 1996, pp. 257-273, to embody manual transmissions with a higher number of gears, e.g. with eight or more gears, as multigroup transmissions, wherein the entire transmission may consist of a main transmission with e.g. four shiftable gearwheel stages as well as a front-mounted group and/or a rear-mounted group that may be designed as a so called splitter or range group. By means of a front-mounted splitter group, the number of gears of the main transmission may for example be doubled and “compressed”, as a result of which finer gear stepping may be achieved. By means of a rear-mounted range group (also called range-change group) the number of gears of the main transmission may likewise be doubled, and at the same time the range of the transmission, i.e. the gear sequence, may be expanded, for example for driving at low speed or at high speed (on the site or on the road).

FIGS. 1A and 1B show a known, manually shiftable multistep transmission 1, having a main transmission 1A with several gears and a rear-mounted group transmission 1B embodied as a range group. The range group 1B has two gears and doubles the number of gears of the main transmission 1A. The first gear of the range group 1B has a transmission ratio of 1:1; when the first gear is engaged, the range group runs in the “high” (fast) range stage.

The second gear of the range group 1B has a higher transmission ratio than the lowest gear of the main transmission; when the second gear is engaged, the range group 1B runs in the “low” (slow) range stage. The range stage is normally preselected before shifting the gears, namely by the driver of the vehicle who actuates a pneumatic or electrical range switch 2B at the shift lever 2A. The range switch 2B controls a pneumatic or electrical 5-way valve 3, through which compressed air is conveyed to a range control motor 5 (pneumatic cylinder). The pneumatic cylinder 5 shifts the range stage into “high” or “low”, the shifting taking place as soon as the previous gear (in the main transmission) is disengaged, that is only when the transmission is in the “neutral” position. This is enabled by the pneumatic 3-way release valve 4, which allows compressed air from a compressed air tank (without reference numeral) to be conveyed to the range switch valve 3 and thus to the pneumatic range cylinder 5.

FIGS. 2A and 2B likewise show a known manual transmission according to the exemplary embodiment of FIG. 1, but additionally provided with a splitter group which has been integrated in the main transmission 1A. In order to actuate the splitter group the shift lever 2A has an additional pneumatic or electrical switch 2C which preselects a “low” or “high” split stage before starting a gear shift. The splitter switch 2C actuates a pneumatic or electrical 5-way switch valve 7 of the splitter group, as a result of which compressed air is conveyed to the splitter control motor 8 (pneumatic cylinder) for shifting the “low” or “high” split stage. The compressed air is conveyed as soon as the clutch pedal 9 is depressed, that is when the clutch is released; only in this state will the 3-way release valve 10 allow the compressed air to be conveyed from the compressed air tank to the switch valve 7 and thus to the pneumatic cylinder 8 for the splitter group.

The gears of the main transmission are normally shifted by means of a mechanical connection 2 between the shift lever 2A and the gear shifting shaft 6 which actuates devices for coupling the gear wheels, e.g. shift sleeves with dog clutch or synchronizer rings by means of rods or forks. The movement of the shift lever for upshifting or reverse shifting the gears (in shift gates) or for selecting the gears by a left-right movement (in a selector gate) results in an H-shaped shift pattern. When the H-shaped shift pattern of the main transmission comprises both range stages (“high” and “low”), this pattern is in general designated as “simple H-shaped shift pattern”, or as “superimposed H-shaped shift pattern” because two H-levels are arranged one on top of the other. Such a “simple H-shaped shift pattern” is shown in FIG. 1B, the gears 1 to 4 being arranged on a lower level and the gears 5 to 8 on an upper level. Manual transmissions with a “simple H-shaped shift pattern” for shifting movements are typically 8-, 9- or 10-gear transmissions, which have no splitter group, and 12-, 13-, or 16-gear transmissions, which in contrast have splitter group.

A problem with the known manual transmissions may arise when the driver of the vehicle forgets to actuate the range switch to preselect the corresponding range stage. In order to prevent such shifting errors different control systems for the prevention of excessively high speeds (over-running speeds) have been introduced in the market. Without going into too much detail regarding the known systems, it may, however, be said that they are based on the fact that shifting errors occur by blocking critical shifting movements. Complete reliability against shifting errors can, however, not be achieved by means of the known over-running speed control systems. In addition, such control systems increase the manufacturing costs of the transmission.

### SUMMARY OF THE INVENTION

The object of the present invention is to prevent shifting errors of the type described above in manual multistep transmissions, and increase the reliability of the transmission and internal combustion engine of the motor vehicle. It is further an object of the invention to provide a method for the prevention of shifting errors, in particular, when shifting a range group. Finally, it is also an object of the invention to provide a suitable device for the performance of the above mentioned method.

According to the present invention, a control device with a “simple H-shaped shift pattern” is provided in a manual transmission which autonomously, i.e. automatically, shifts the range group, a rotational speed sensor detecting the transmission output rotational speed being provided on one side, and a sensor for the detection of the gear to be shifted, i.e. the corresponding shift gate, being provided on the other side. By means of the invention, range group shifting is automated, that is the driver of the vehicle no longer has to preselect the corresponding range stage by hand—in this way individual shifting errors are excluded. In addition, the known costly over-running speed control systems may be dispensed with. The control device according to the present invention thus shifts the correct “high” or “low” range stage on the basis of the measured output rotational speed and the detected shift gate so that over-running speeds are prevented. Such a control device according to the present invention may advantageously be used in multistep transmissions with a range group.

According to a preferred embodiment of the invention, in addition to the range group, the main transmission may also have a splitter group which is preferably arranged upstream of the main transmission. For this purpose, the control device additionally has a sensor for the detection of the preselected split stage. With this, the automated range stage shifting according to the present invention may also be applied to multigroup transmissions consisting of a main transmission, range group and splitter group.

According to a preferred embodiment, the rotational speed sensor may be embodied as an inductive rotational speed sensor. Thus, contactless, cost-effective measurement of the transmission output rotational speed and a corresponding signal generation for the control device is possible.

According to a further preferred embodiment, the sensor for the detection of the shift gate comprises an emitter part and a receiver part, the emitter part having two different cams which are arranged on the shift shaft of the transmission. The receiver part comprises a contact pin which slides on either one or the other cam and thus generates a signal for the control device which represents the shift gate of the gear to be selected.

According to further preferred embodiments, the splitter group may be embodied as an upstream group, and the range group as a downstream group with respect to the main transmission. In this way, a compact design of the entire transmission and advantageous gear stepping as well as a high number of gears is possible. In particular, an 8-, 9-, 10-, 12-, 14- or 15-gear transmission may be implemented.

The object of the invention is also attained by a method, which, for a transmission with range group, but without splitter group, is based on the measurement of the transmission output rotational speed and the detection of the shift gate of the gear to be shifted. Moreover, three different conditions are defined as criterion for the preselection of the range stage, namely a lower rotational speed range (zone A), a high rotational speed range (zone B) and a middle rotational speed range (zone C). The “low” range stage is allocated to zone A independently of the gear to be selected, the “high” range stage is allocated to zone B independently of the gear to be shifted, and either the “high” or “low” range stage is allocated to zone C, but depending on the gear to be shifted, i.e. on the shift gate detected by the sensor. With this, a clear allocation for the automated course of the range stage shifting is given that guarantees high reliability.

According to the present invention, the mechanism is characterized by a control device which comprises a sensor for the measurement of the transmission output rotational speed and for the detection of rotational speed signal, a sensor for the detection of the gear to be shifted, i.e. of the dedicated shift gate, and for the generation of gear signal, a control motor for shifting the range stages and an electronic control unit for processing the signals generated by the sensors and for activating the control motor. The mechanism according to the present invention may be implemented in known, commercially available manually shiftable multigroup transmissions without incurring considerable expenses. The method according to the present invention may advantageously be implemented and the shifting reliability of the transmission be increased by means of such a mechanism.

### BRIEF DESCRIPTION OF THE DRAWINGS

Exemplary embodiments of the invention are shown in the drawings and will be explained hereinafter in more detail. The drawings show:

FIGS. 3A and 3B a manual transmission according to the present invention with a range group and control device,

FIGS. 4A and 4B a manual transmission according to the present invention with a splitter and range group as well as a control device,

FIGS. 5A and 5B “simple H-shaped shift patterns” for different numbers of gears (8 to 16),

FIG. 6 a rotational speed diagram for a 9-gear transmission,

FIGS. 7A-7D a rotational speed diagram for a 9-gear transmission

FIGS. 8A-8D a rotational speed diagram for a 10-gear transmission,

FIG. 9 a rotational speed diagram for a 16-gear transmission with a splitter group,

FIGS. 10A(1)-10A(4) and 10B(1)-10B(4) a rotational speed diagram for a 16-gear transmission with shift patterns,

FIGS. 11A(1)-11A(4) and 11B(1)-11B(4) a rotational speed diagram with shift patterns for a 12-gear transmission,

FIGS. 12A-12D a rotational speed diagram with shift patterns for a 13-gear transmission,

FIGS. 13A(1)-13A(4) and 13B(1)-13B(4) a rotational speed diagram with shift patterns for a 14-gear transmission,

FIG. 14 a control device for automatically shifting a range group with a function scheme for zone A,

FIG. 15 the control device with a function scheme for zone B,

FIG. 16 the control device with a function scheme for zone C and the shift gate “La”,

FIG. 17 the control device with a function scheme for zone C and the shift gate “Lb” and,

FIG. 18 an expanded control device for a transmission with splitter group

### DETAILED DESCRIPTION OF THE PREFERRED EMBODIMENTS

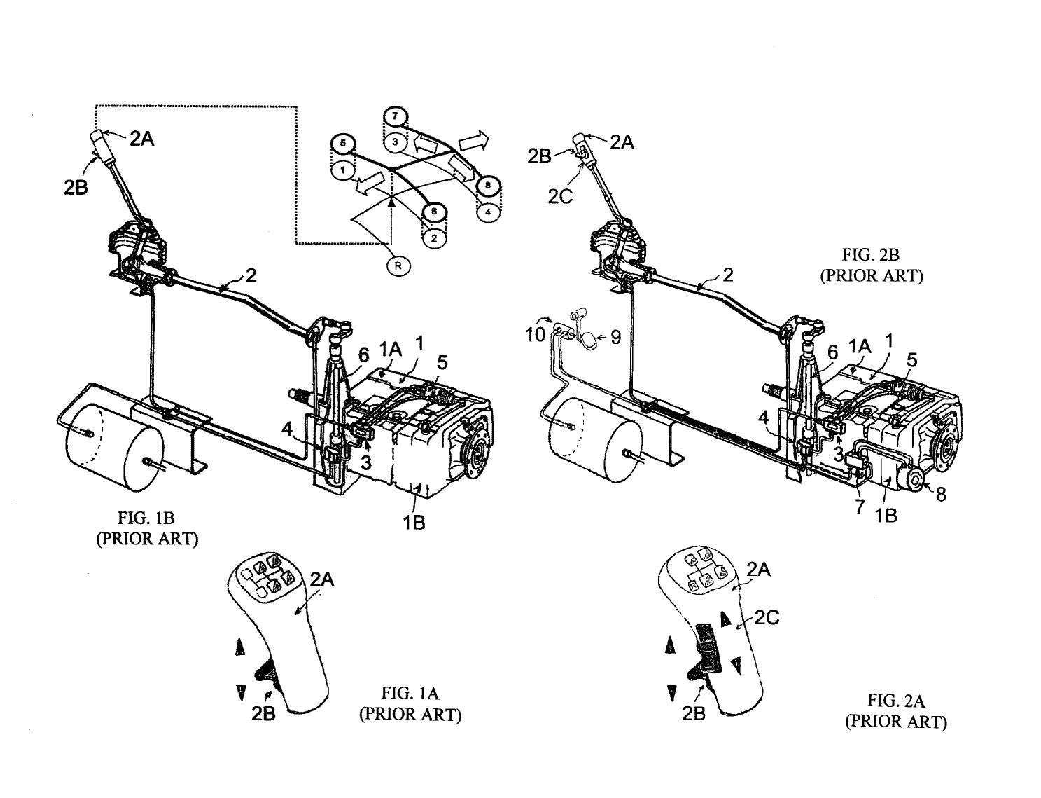

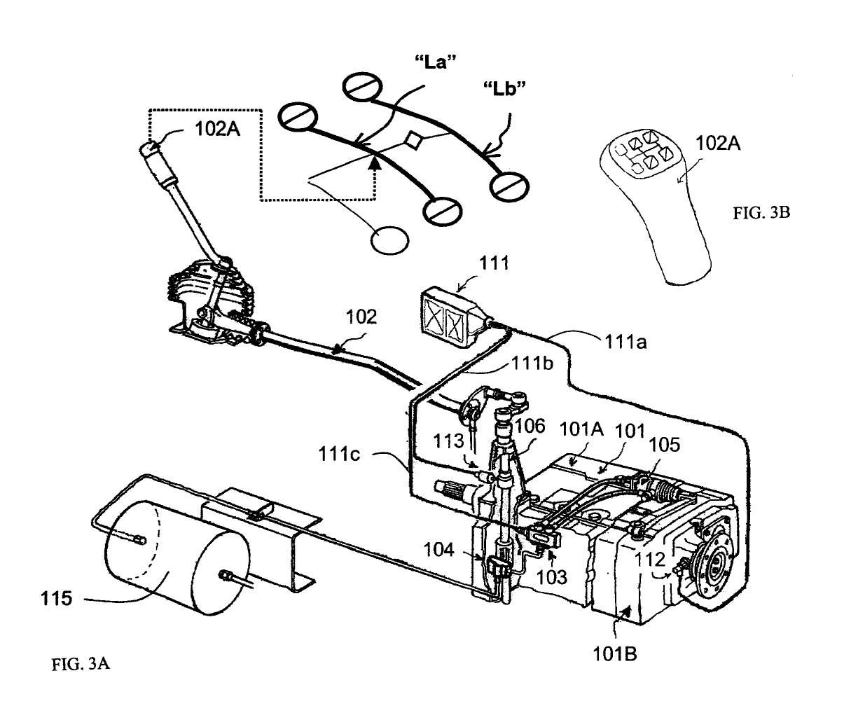

FIGS. 3A and 3B show a schematic representation of a first exemplary embodiment of the invention which in part corresponds to the known transmission shown in FIGS. 1A and 1B; in this respect, the reference numerals used in FIGS. 1A and 1B are used increased by 100 for similar parts in FIGS. 3A and 3B. The drawings show a manual transmission 101 comprising a main transmission 101A and a rear-mounted transmission embodied as a range group 101B. The transmission 101 is used for a motor vehicle, embodied as a multistep transmission and shifted by means of a shift lever with shift knob 102A, a mechanical connection 102 and a gear shift shaft 106. The range group 101B is shifted by means of a pneumatic cylinder 105 which is activated by a pneumatic switch valve 103. The compressed air is conveyed from a compressed air reservoir 115 by means of a release valve 104. The manual transmission 101 has a dedicated electronic control unit 111 which is connected by means of signal lines 111a, 111b, 111c to an inductive rotational speed sensor 112 for the detection of the transmission output rotational speed, to a sensor for the detection of the shift gate of the gear to be shifted embodied as an electrical switch 113, as well as to a switch valve 103 for shifting the range group 101B. The individual gears are shifted by means of the shift lever 102A according to a “simple H-shaped shift pattern”, i.e. by means of right-left movement in a so called selector gate and backward and forward movement in two shift gates designated with the letters “La” and “Lb”. The transmission 101 shown in FIG. 3A has no splitter group.

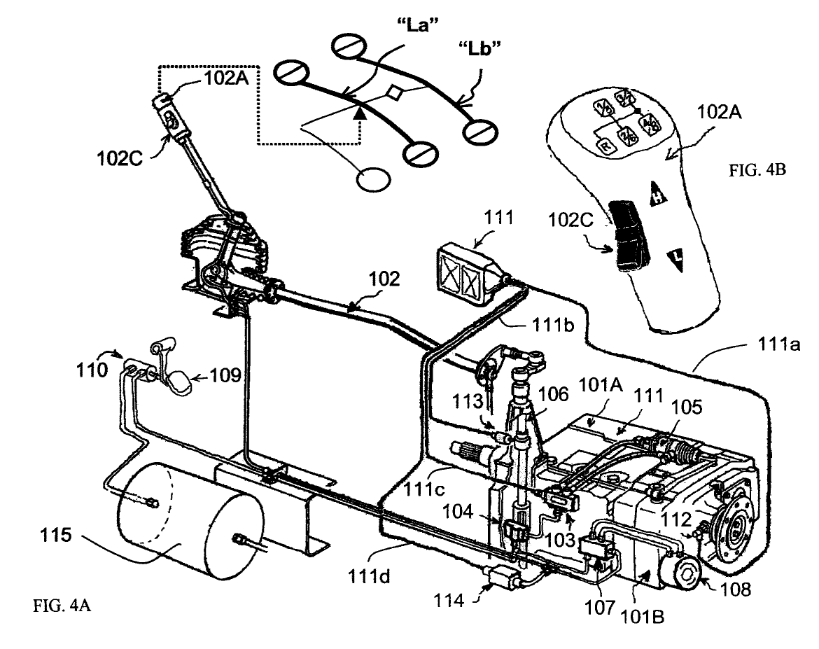

FIGS. 4A and 4B show a second exemplary embodiment of the invention which corresponds to the known transmission with splitter group according to FIGS. 2A and 2B. The reference numerals in FIGS. 4A and 4B are the same as far as they involve the same parts as in FIGS. 2A and 2B, but increased by 100. In addition to the range group 101B, the transmission 101 has a splitter group, which is not shown, integrated in the main transmission 101A that is activated by means of a pneumatic switch 102C at the shift knob 102A. The driver of the vehicle may shift a split stage into “high” and a split stage into “low” by means of the switch 102C. In addition to the transmission according to FIGS. 3A and 3B, the transmission shown in FIGS. 4A and 4B has an electropneumatic switch valve 107 for activating a control motor 108 (pneumatic cylinder), by means of which the split stages are shifted. The pneumatic cylinder 115 supplies compressed air by means of a release valve 110 which is open when the clutch pedal 109 is depressed. The electronic control unit 111 is additionally connected by means of a control line 111d to an electrical pneumatic switch 114 which detects the preselection of the split stage. The switch 114 thus functions as a further sensor for the detection of the respective split stage.

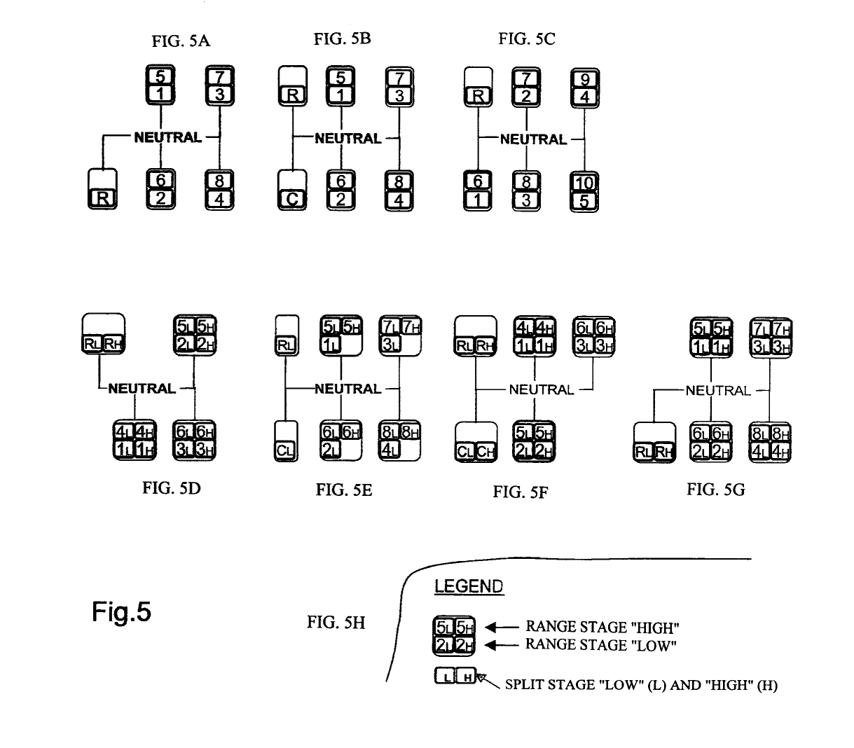

FIGS. 5A-5H show different shift patterns for transmissions with multiple gears for a transmission with range and splitter group, that is FIG. 5A for 8 gears, FIG. 5B for 9 gears, FIG. 5C for 10 gears, FIG. 5D for 12 gears, FIG. 5E for 13 gears, FIG. 5F for 14 gears, and FIG. 5G for 16 gears. All shift patterns 5A-5G are “simple H-shaped shift patterns”, the gears being designated with numbers and letters: letter R stands for reverse gear, letter C stands for crawler or creep speed. The legend shown in FIG. 5H explains the shifting system: “5L” stands for 5^{th} gear, “high” range stage and “low” split stage.

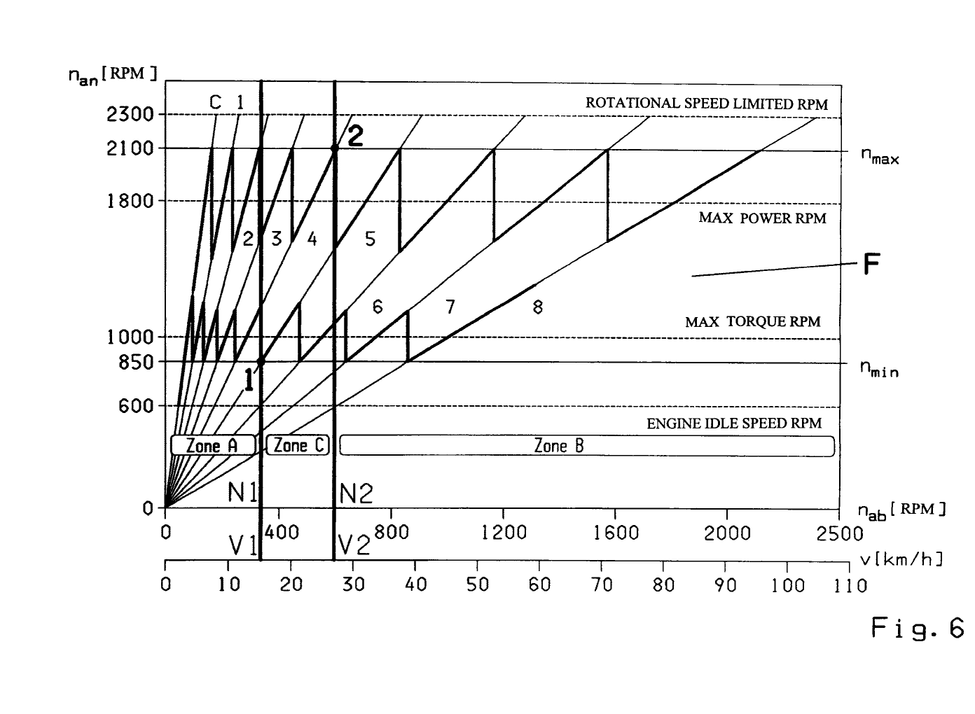

FIG. 6 shows a rotational speed diagram for which an exemplary 9-gear transmission has been selected whose shift pattern is shown as FIG. 5B. The input rotational speed nₐₙ, which corresponds to the engine rotational speed, is plotted in rpm (revolutions per minute) along the y-axis, the output rotational speed n_{ab} of the transmission is plotted in rpm along the x-axis and the vehicle speed v is in parallel plotted in km/h. The diagram shows the mathematical relation between input rotational speed and output rotational speed for each gear. The following rotational speeds are plotted in the diagram: In the selected example, the idle speed of the engine is 600 rpm, the maximum engine power is achieved at a rotational speed of 1800 rpm, and the maximum torque is achieved at a rotational speed of approximately 1000 rpm The cut-off rotational speed is 2300 rpm. According to the present invention, a lower shift limit of nₘᵢₙ=850 rpm and an upper shift limit of nₘₐₓ=2100 has been established. As soon as the speed lines of the individual gears, which are plotted in the diagram as rays C, 1, 2, 3, 4, 5, 6, 7, 8, reach the upper or lower shift limit, the shifting process should be started. The field between both shift limits nₘᵢₙ and nₘₐₓ is designated as shift range F. The shift range F thus defines the optimal shift range so that the engine of the motor vehicle is neither run at high revs (near the cut-off rotational speed) nor at low revs (too close to the idle speed).

According to the present invention, the shift range F is divided into three zones A, B, C, namely by two specific output rotational speed values, namely N1 and N2: The first rotational speed value N1 is defined by the point of intersection “1” of the lower shift limit nₘᵢₙ with the gear speed line of the lowest gear that is engaged in the range stage “high”. The second speed value N2 is defined by the point of intersection “2” of the upper shift limit nₘₐₓ and the gear speed line of the highest gear that may be engaged in the range stage “low”.

Zone A corresponds to the operating state in which the output rotational speed n_{ab} detected by the inductive rotational speed sensor is lower or equal to the value N1 (n_{ab}≦N1).

Zone B corresponds to the operating state in which the output rotational speed n_{ab} is greater than the value N2 (n_{ab}>N1).

Zone C corresponds to the operating state in which the transmission output rotational speed n_{ab} is greater than N1 and smaller than or equal to N2 (N1<n_{ab}≦N2).

It is evident that two of the three zones, namely zone A and zone B are clearly related to the required “low” or “high” range stage. When the transmission operates in zone A, that is when n_{ab}≦N1, the range group has to be in the “low” stage, whichever gear may be engaged, or it has to be shifted into the “low” stage because only the low speed of the range stage can operate in zone A. In this situation the “low speed” (often also called crawler or creep speed) and the reverse gears obviously are of interest.

As has already been mentioned, an electronic control unit may detect the transmission output rotational speed by means of an inductive sensor in order to identify the operating zone A and thus anticipate the “low” stage of the range group and also preselect it.

When the transmission operates in zone B, that is when n_{ab}>N1, the range group has to be in the “high” stage, whichever gear may be engaged, or it has to be shifted into the “high” stage because only the gears of the range stage “high” can be operative in zone B. As mentioned above, an electronic control unit may identify the operating zone B by measuring the transmission output rotational speed by means of an inductive sensor and detect the “high” stage of the range group as well as also preselect it. When the transmission operates in zone C, that is when N1<N_{ab}≦N2, the (“low” or “high”) range stage cannot clearly be identified because both “high”, or “low” range stages may be necessary. An additional reference may be useful in this case, namely the identification of the shift gate of the gear to be shifted on the basis of the H-shaped shift pattern. The corresponding shift gate “La” or “Lb” of the H-shaped shift pattern of the gear to be shifted may be identified by means of a suitable sensor that detects the shifting movement of the shift lever. The sensor may be of any type, e.g. electrical or pneumatic, and may be arranged anywhere within the shifting movement between the shift lever and the gearwheel clutches (synchronizing clutches).

As is apparent from FIG. 6, always with reference to an exemplary 9-gear transmission, the following gears may be shifted in zone C:

the 3^{rd} gear (corresponding to the 3^{rd} gear in the “low” range stage) and the 4^{th} gear (corresponding to the 4^{th} gear in the “low” range stage), both gears being located in the shift gate “Lb” (cf. FIG. 3A and FIG. 5B),

the 5^{th} gear (corresponding to the 1^{st} gear in the “high” range stage) and the 6^{th} gear (corresponding to the 2^{nd} gear in the “high” range stage), both gears being located in the shift gate “La” (likewise cf. FIG. 3A and FIG. 5B).

The electronic control unit, which has detected the operating zone C by means of the inductive rotational speed sensor, identifies the preselection of the “high” or “low” range stage on the basis of the detected shift gate. the preselection of the “low” range stage is associated with the 3^{rd}-4^{th} gear shift gate (“Lb”), whereas the preselection of the “high” range stage is associated with the 1^{st}-2^{nd} gear shift gate (“La”).

If, for example, the 6^{th} gear should be engaged, the shift gate sensor identifies the 1^{st}-2^{nd} gear shift gate (“La”) while the 6^{th} gear is selected; the electronic control unit, which in the meantime has identified the zone C by means of the inductive rotational speed sensor, associates the detected 1^{st}-2^{nd} gear shift gate (“La”) with the preselection of the “high” range stage.

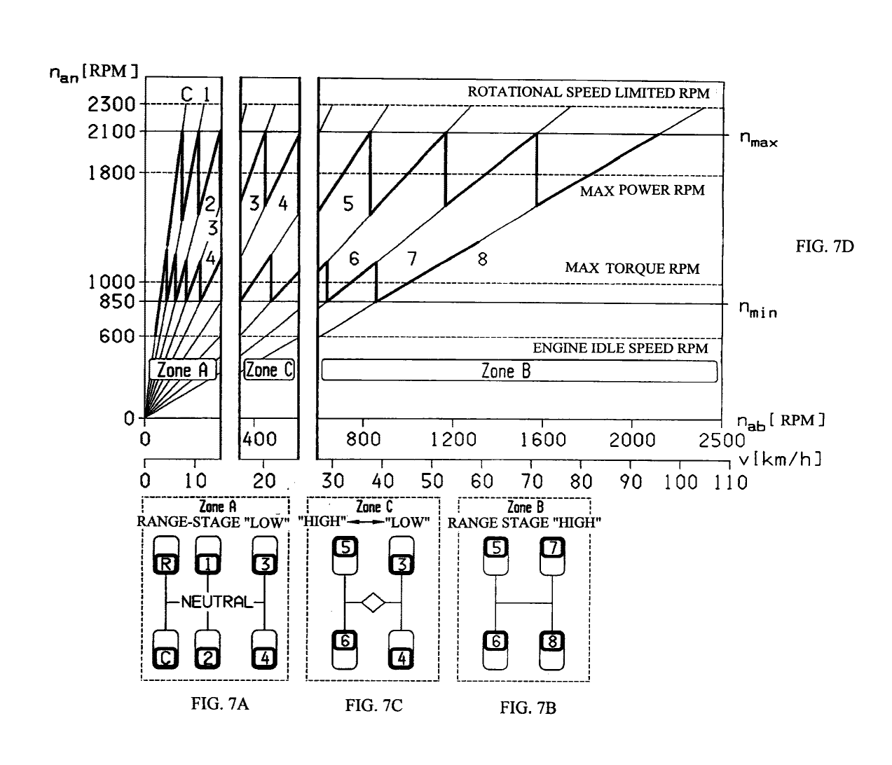

FIGS. 7A-7D show a gear shifting scenario for a 9-gear transmission (with reference to the shift pattern of FIG. 5B). The rotational speed diagram corresponds to that of FIG. 6, that is the input rotational speed nₐₙ is plotted in rpm along the y-axis, the output rotational speed n_{ab} is plotted in rpm along the x-axis, and the vehicle speed v is plotted in km/h. The rotational speed diagram for the individual gears refers to a vehicle with an engine, whose maximum torque is achieved at 1000 rpm, whose maximum power is achieved at 1800 rpm, which has an axle drive ratio of 2.93 and a transmission ratio of 1:12.9 as well as a tire radius of 0.5 m. The scenario may also be transferred to an 8-gear transmission (with reference to FIG. 5A), which is similar to the design concept of the 9-gear transmission, but without creep speed (crawler). In addition to the rotational speed diagram, FIGS. 7A-7D shows the shift patterns for zones A, C, B with the respective range stages which do not require any further explanation. The invention may also be applied to a 10-gear transmission according to FIG. 5C.

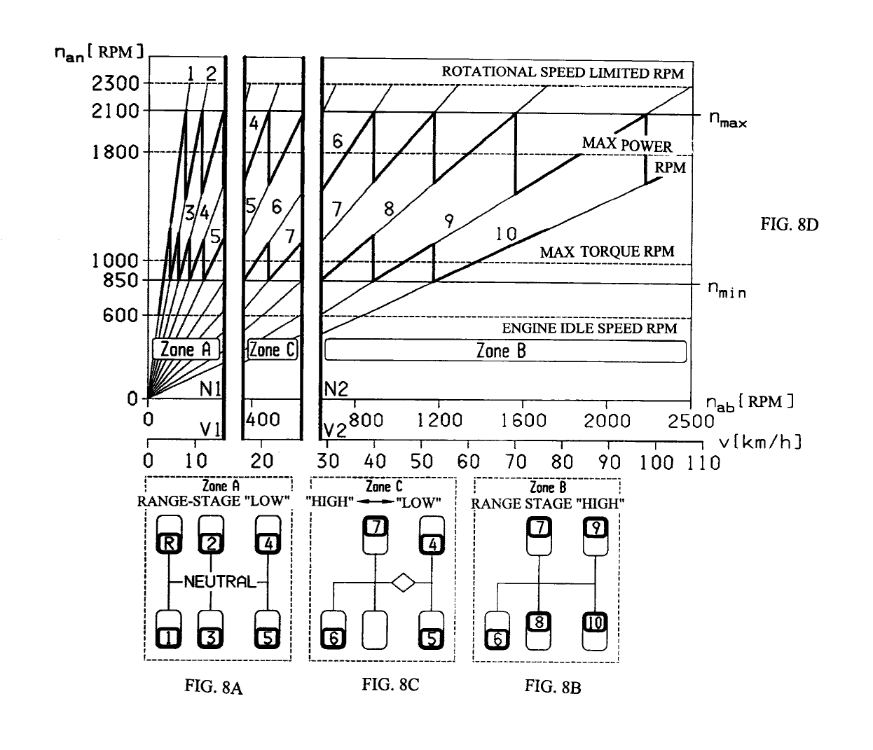

FIGS. 8A-8D shows a speed diagram for a 10-gear transmission as well as the shift pattern dedicated to zones A, C, B with the respective range stage. The rotational speed diagram corresponds to a vehicle with an axle drive ratio of 2.93 and a transmission ratio of 1:14.8 as well as a tire radius of 0.5 m. Manual transmissions with more than 10 gears normally have a splitter group with two split stages (split speeds), the splitter group being integrated in the main transmission and also in part in the range group, or placed in the housing of the range group. Such transmissions have 12, 13, 14, and 16 gears—the invention is also applicable to these transmissions.

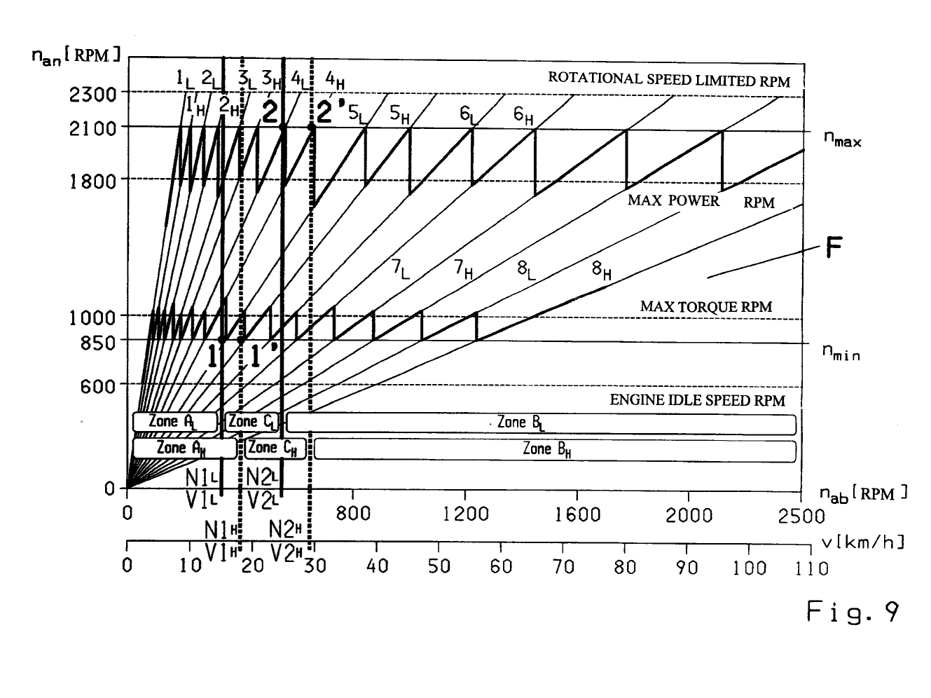

FIG. 9 shows a rotational speed diagram with an operative shifting range F, which is limited by a lower shift limit nₘᵢₙ and an upper shift limit n_{max,} for a transmission with 16 gears, that is with a splitter group. The rotational speed diagram has been created according to the same rules and definitions, as described above with regard to FIG. 6. Likewise, the three zones A, B, C are defined similarly to the preceding diagrams. The designations of the low gears in the “high” range stage and of the higher gears in the “low” range stage have, however, been changed due to the splitter group. The “low” or “high” split stage is preselected by the splitter switch at the shift knob before the shifting process is started; this means that when the “low” split stage is preselected, the low gear is then the 9^{th} gear in the “high” range stage according to the designation 5L in the main transmission. In contrast, according to the designation 5H in the main transmission, the 10^{th} gear is available when the “high” split stage is preselected. Likewise, the higher gear is the 7^{th} gear in the “low” range stage, according to the designation 4L in the main transmission, when the “low” split stage is preselected. In contrast, according to the designation 4H in the main transmission, the 8^{th} gear is available when the “high” split stage is preselected. Based on this fact, zones A, B, C change their position in the shifting range, namely in relation to the preselected (“low” or “high”) split stage, as it is illustrated in FIG. 9. The points of intersection “1” and “2” change their values to N1_{L} and N2_{L} as soon as the “low” splitter group is preselected, and, in contrast, to N1_{H} and N2_{H} as soon the “high” splitter group is preselected.

The electronic control unit may detect the preselection of the split stage by means of the position of the splitter switch, which may be an electrical or pneumatic-electrical switch, and may likewise adjust the positions of zones A, B and C. The range stage is preselected according to the same method as described above.

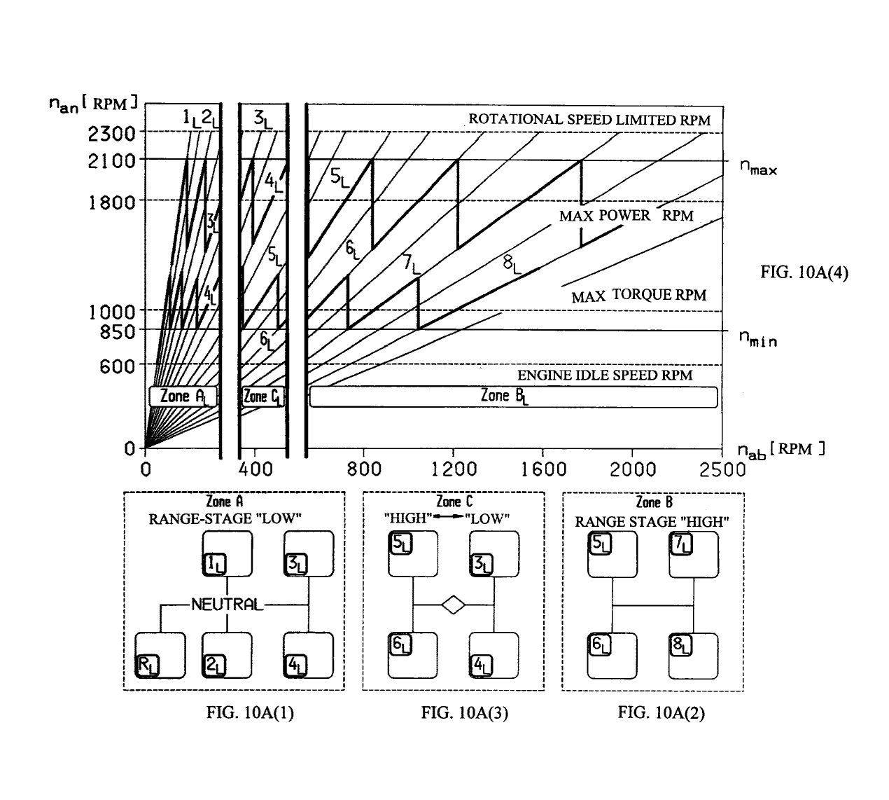

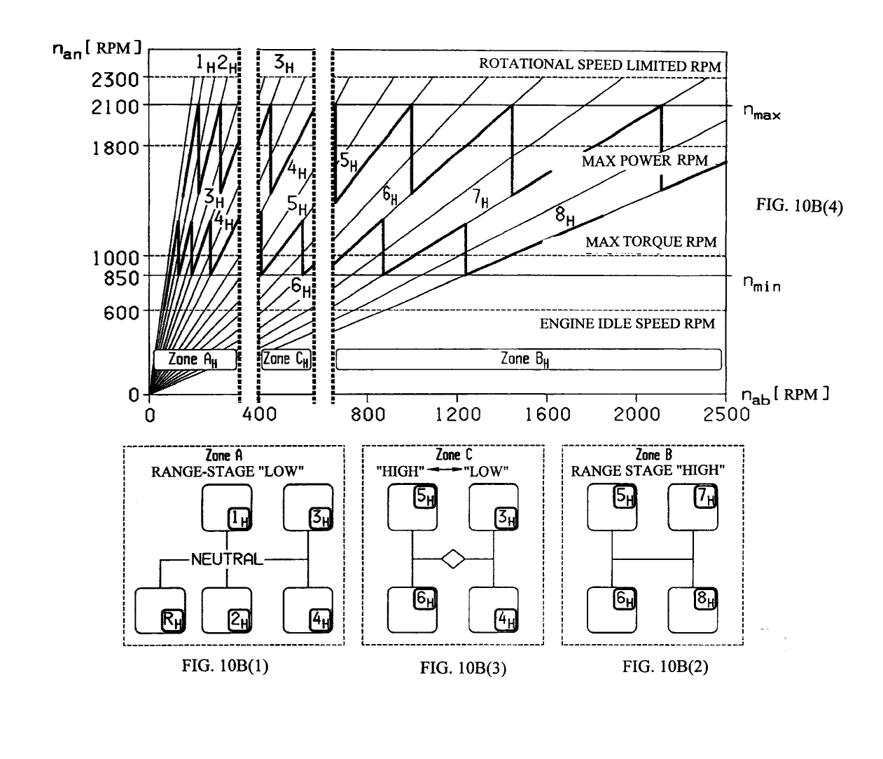

FIGS. 10A(1)-10A(4) and 10B(1)-10B(4) shows a gear shifting scenario for a 16-gear transmission (with reference to FIG. 5G). The rotational speed diagram refers to a vehicle, in which the maximum engine torque is achieved at 1000 rpm, the maximum engine power is achieved at 1800 rpm, the axle drive ratio is 2.93, the transmission ratio is 1:16.4 and the tire radius is 0.5 m. The upper diagrams, FIGS. 10A(1)-10A(4), show the gear speed lines 1L, 2L, 3L, . . . , to 8L with the zones A_{L}, B_{L} and C_{L} for the “low” split stage (L=low). The lower rotational speed diagrams, FIGS. 10B(1)-10B(4), show the gear speed lines 1H, 2H, 3H, . . . , to 8H as well as the displaced zones A_{H}, B_{H}, C_{H} for the “high” split stage (H=high). In addition, the shift patterns with the respective range stage for each diagram are shown laterally.

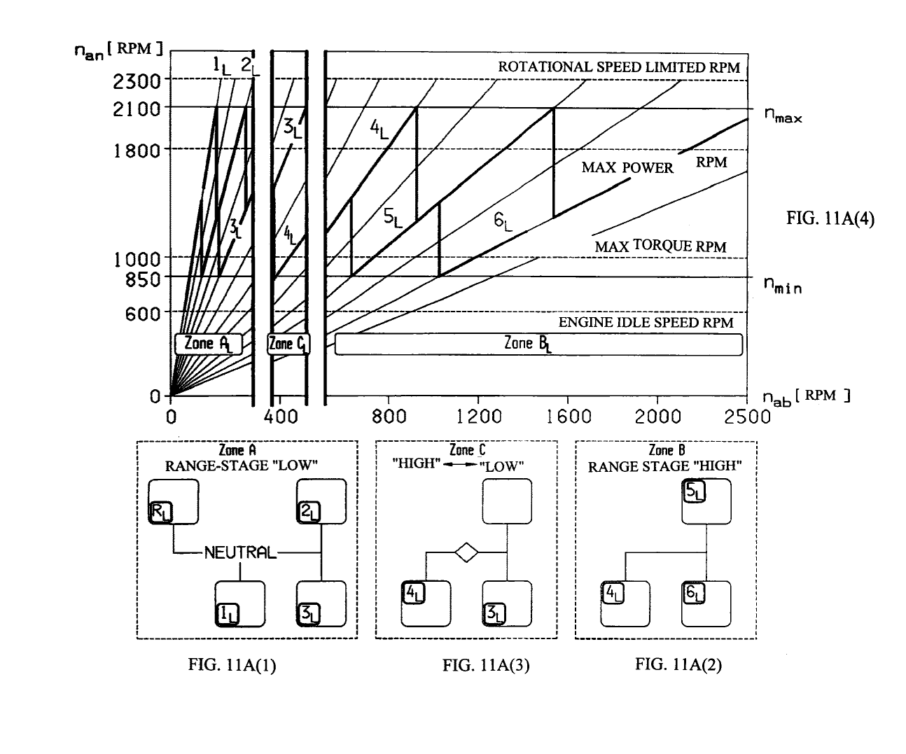

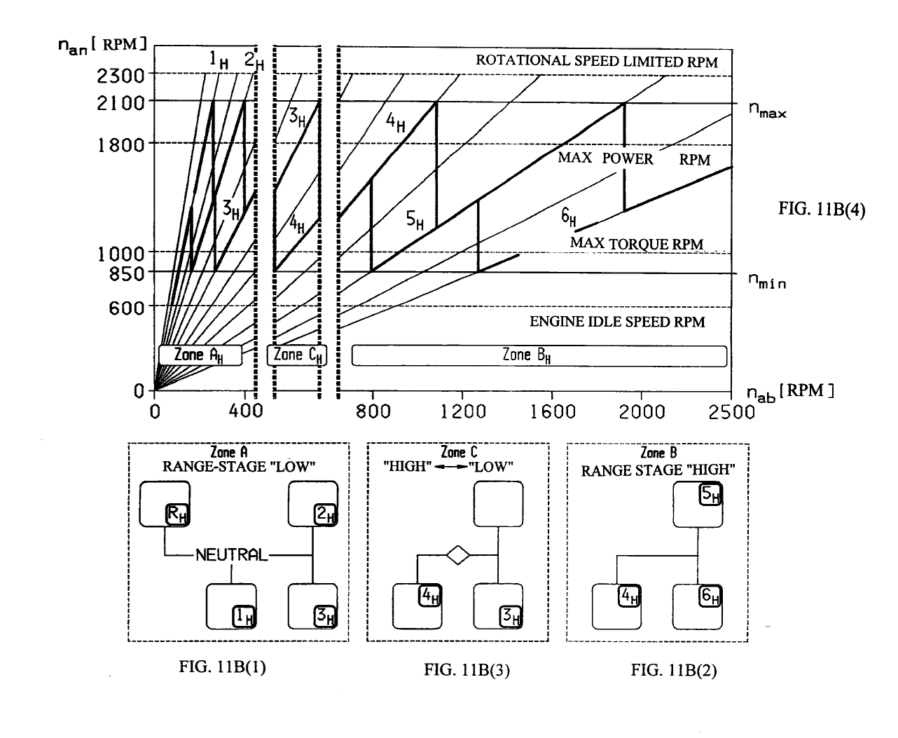

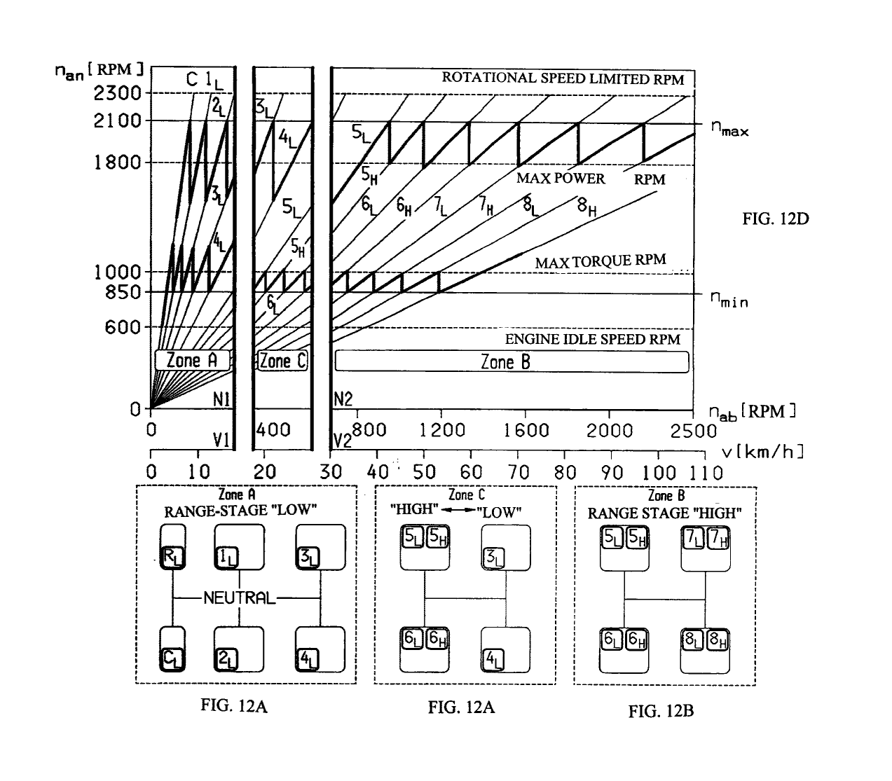

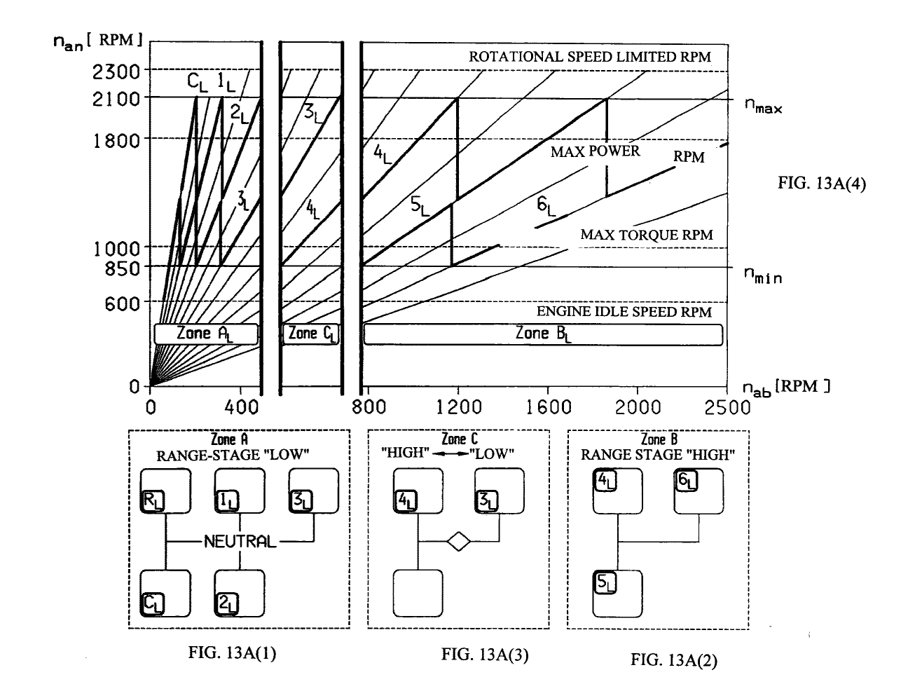

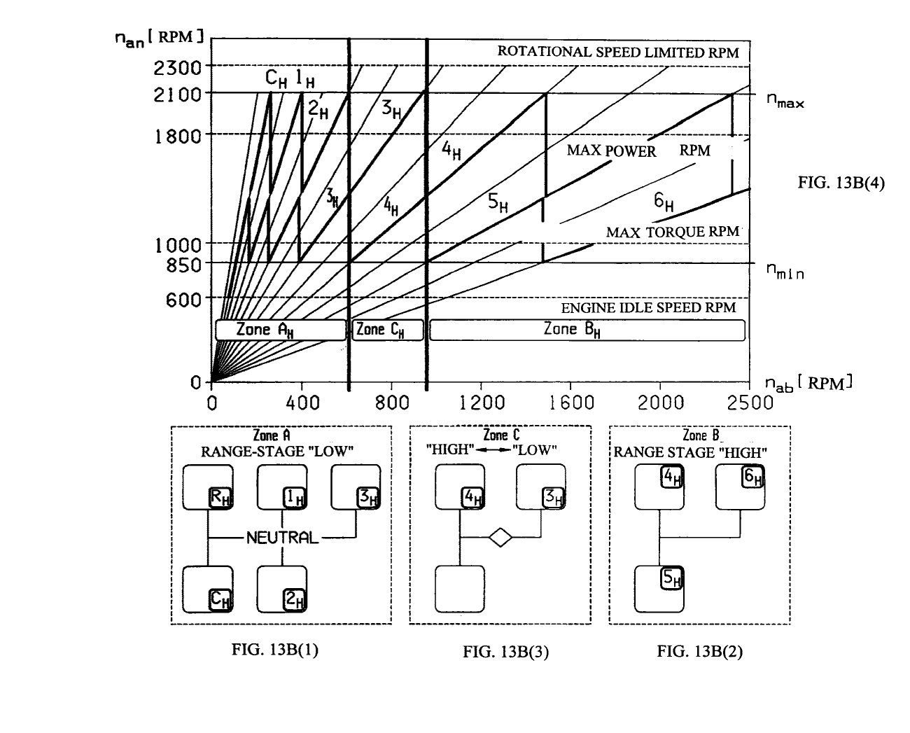

FIGS. 11A(1)-11A(4), 11B(1)-11B(4) 12A-12D, 13A(1)-13A(4) and 13B(1)-13B(4) show the applications of the invention to a 12-gear transmission (with reference to the shift of FIG. 5D), to a 13-gear transmission (with reference to the shift pattern FIG. 5E) and to a 14-gear transmission (with reference to the shift pattern FIG. 5F). The diagrams refer to a vehicle, in which the maximum engine torque is achieved at 1000 rpm and the maximum engine power is achieved at 1800 rpm, the axle drive ratio is 2.93, the transmission ratio is 1:12.9 and the tire radius is 0.5 m. The index L in the diagrams in turn stands for “low” split stage (L=low), whereas the index H stands for “high” split stage (H=high). Apart from the rotational speed diagrams, the figures show the corresponding shift patterns for the gears that may be shifted in the each zone.

In summary, it can be said that the present invention is based on the following concept:

for transmissions without a splitter group, the electronic control unit is programmed by defining and entering the values “N1” and “N2”;

for transmissions with a splitter group, the electronic control unit is programmed by defining, entering and storing the values “N1L” and “N2L”; “N1H” and “N2H” in rpm;

the operating zones A or B or C are continuously detected when the transmission is running, namely by the inductive rotational speed sensor which measures the output rotational speed (the speed of the transmission output shaft) in rpm;

preselection of the “low” range stage, if the transmission is running in the operating zone A, or

preselection of the “high” range stage, if the transmission is running in the operating zone B, or

preselection of the “high” range stage, if the transmission is running in zone C and the “La” shift gate is selected in the interim, or

preselection of the “low” range stage, if the transmission is running in zone C and the “Lb” shift gate is selected in the interim.

The gear from which the shifting process starts has no influence on the monitoring of the shifting process or of the shifting strategy. The present invention is applicable to manually shiftable multistep transmissions having a range group, which doubles the gears of the main transmission, i.e. transmissions with 8, 9, 10, 12, 13, 14 and 16 gears and a shifting pattern of the “simple H-shaped” type, whose diagram is shown in FIGS. 5A-5H.

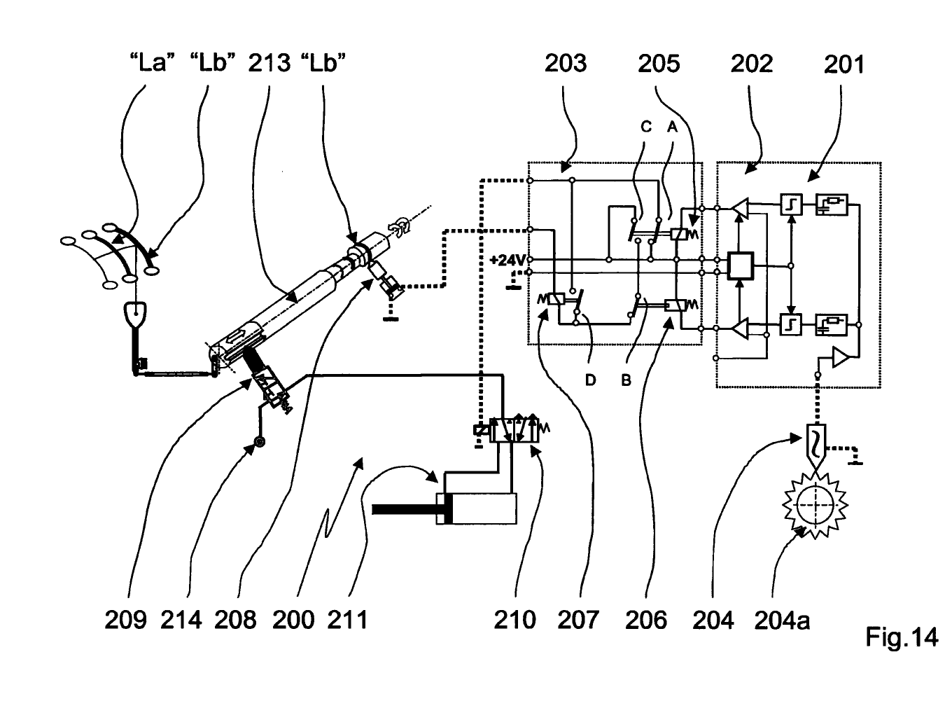

FIG. 14 shows a control device 200 as a preferred exemplary embodiment of the invention for automatically shifting the range stage. The control device 200 comprises an electronic control unit 201, which has two modules, a first electronic module 202 and a second electronic module 203. The control device 200 further comprises an inductive rotational speed sensor 204 which is arranged at the output shaft of the transmission and generates a rotational speed signal. The control device 200 further comprises a shift element 213 which may correspond to the gear shift shaft 106 shown in FIGS. 3A and 4A. Two different cams are arranged on the shift element 213, which correspond to the above described shift gates La, Lb, one of the cams is designated with “Lb”. An electric switch 208 is allocated to each of the two cams on the shift element 213, the electric switch 208 respectively contacting one or the other cam. The shift element 213 on the one hand carries out a rotational movement about its longitudinal axis corresponding to the shifting movement in a shift gate (La, Lb). The shift element 213 on the other hand also carries out a longitudinal movement in the direction of its longitudinal axis corresponding to the selection movement of the shift lever into the selection program. The control device 200 further comprises a pneumatic control motor 211, also called pneumatic cylinder, which is activated by an electropneumatic switch valve 210.

The first electronic module 202 comprises electronic devices, which are suitable for processing the output signal of the inductive rotational speed sensor 204, also called rotational speed signal. The second electronic module 203 comprises three electromagnetic relays 205, 206, 207. The rotational speed signal coming form the rotational speed sensor 204 is embodied as a square wave signal, whose frequency results from the product of the transmission output rotational speed and the number of teeth of the pulse wheel 204a on the output shaft. The module 202 amplifies the rotational speed signal into two branch lines. The first branch line has electronic devices which compare the frequency of the input signal to the frequency of a value, which corresponds to the rotational speed value N1 (cf. description of FIG. 6), energizing the electromagnetic relay 205 of the second module 203, when the frequency of the input signal is higher than the frequency corresponding to the rotational speed value N1, i.e. when n_{ab}>N1. The second branch line has electronic devices, which compare the frequency of the input signal to the frequency corresponding to the rotational speed value N2, energizing the electromagnetic relay 206 of the second module 203, when the frequency of the input signal is higher than the speed value N2, i.e. when n_{ab}>N2.

The electromagnetic relays 205, 206, 207 may be energized or deenergized depending on the value available for the output rotational speed n_{ab}, that is whether the transmission is running in the operating zone A, B or C.

In zone A, i.e. n_{ab}≦N1 the following holds:
the relay 205 is not energized, contact A is closed, contact C is open; the relay 206 is deenergized, contact B is closed. The relay 207 is not operative.

In zone B, i.e. n_{ab}>N2 the following holds:
the relay 205 is energized, contact A is open, contact C is closed; the relay 206 is energized, contact B is open. The relay 207 is not operative.

In zone C, i.e. N1<n_{ab}≦N2 the following holds:
the relay 205 is energized, contact A is open, contact C is closed; the relay 206 is deenergized, contact B is closed. The relay 207 is not operative.

The electrical switch 208, which is arranged at the shift element 213, detects the shift gate by means of the cam's shape. If the gear to be shifted is in the shift gate “La”, the contact of the switch 208 is open. On the other hand, the contact of the switch 208 is closed when the gear to be shifted is in the shift gate position “Lb”, as a result of which the relay 207 is energized and contact D closed if the transmission is meanwhile running in zone C.

The pneumatic 5-way valve 210 switches the compressed air for the range group to the pneumatic control motor 211. When the magnetic coil of the valve 210 is energized, the “low” range stage is preselected, whereas the “high” range stage is preselected when the magnetic coil is deenergized.

Range shifting only takes place if no gear is engaged in the main transmission, that is, when the transmission is in the “neutral” position.

FIG. 14 shows the system design of a transmission with splitter group and its function when the transmission is in the operating state of zone A. The relay 205 is deenergized, contact A is closed, consequently, the magnetic coil of the switch valve 210 is energized, as a result of which the “low” range stage is preselected, independently of the shift gate of the gear to be shifted because the switch 208 is not operative. (The pneumatic piston in the pneumatic cylinder 211 is on the left side.)

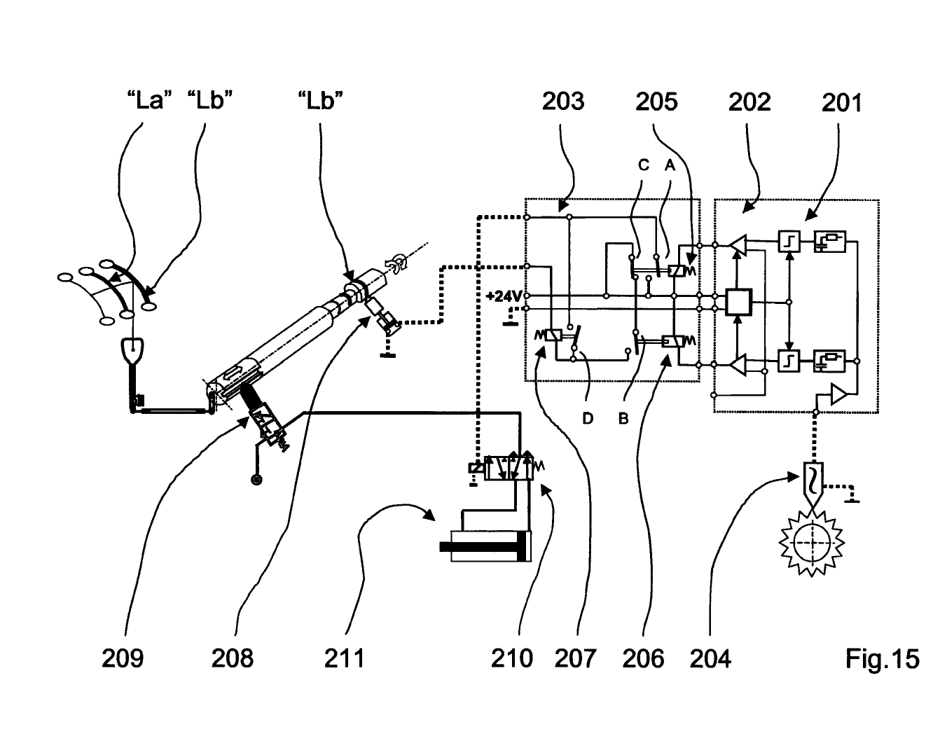

FIG. 15 shows the functional situation when the transmission is in zone B. The drawing as well as the reference numerals basically correspond to the previous figure. The relay 205 is energized, contact A is open, and contact C is closed. The relay 206 is energized, and contact B is open. The magnetic coil of the switch valve 210 for the range group is deenergized, as a result of which the “high” range stage is preselected, independently of the shift gate of the gear to be shifted because the switch 208 is not activated. (The pneumatic piston is on the right side of the pneumatic cylinder 211.)

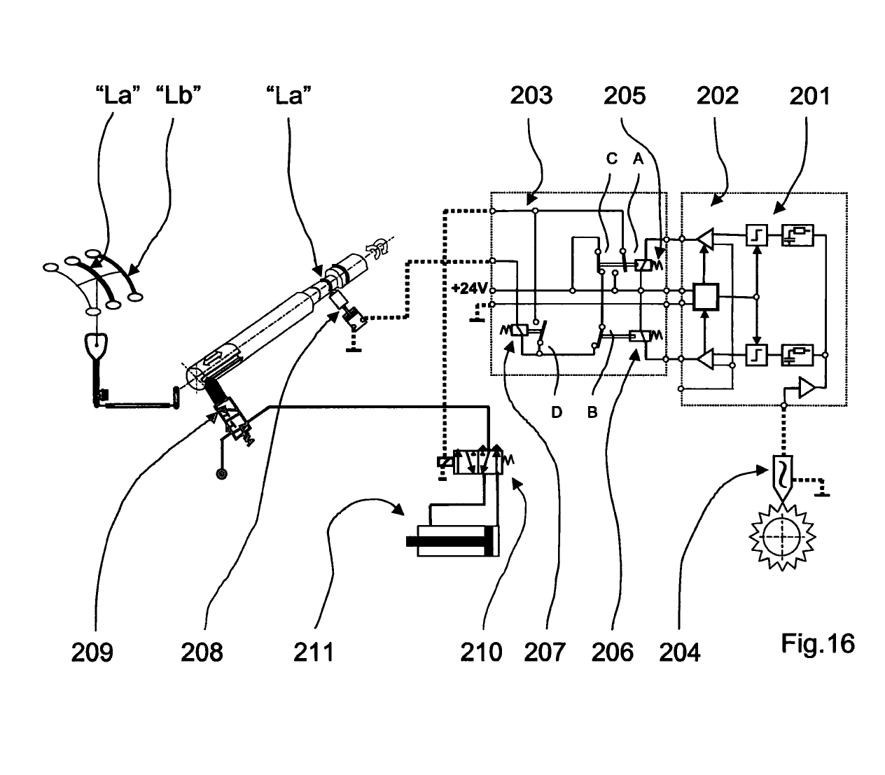

FIG. 16 shows the functional situation when the transmission is in zone C, and the gear to be shifted is in the shift gate “La”. Both the relays 205 and 206 are energized, contact A is open, and contact B is closed. Contact C is likewise closed. The electromagnetic relay 207 is now energized, the switch 208 is open, thus the relay 207 is deenergized, contact D is open so that the magnetic coil of the switch valve 210 is deenergized, thus the “high” range stage is preselected (the pneumatic piston in the pneumatic cylinder 211 is on the right side).

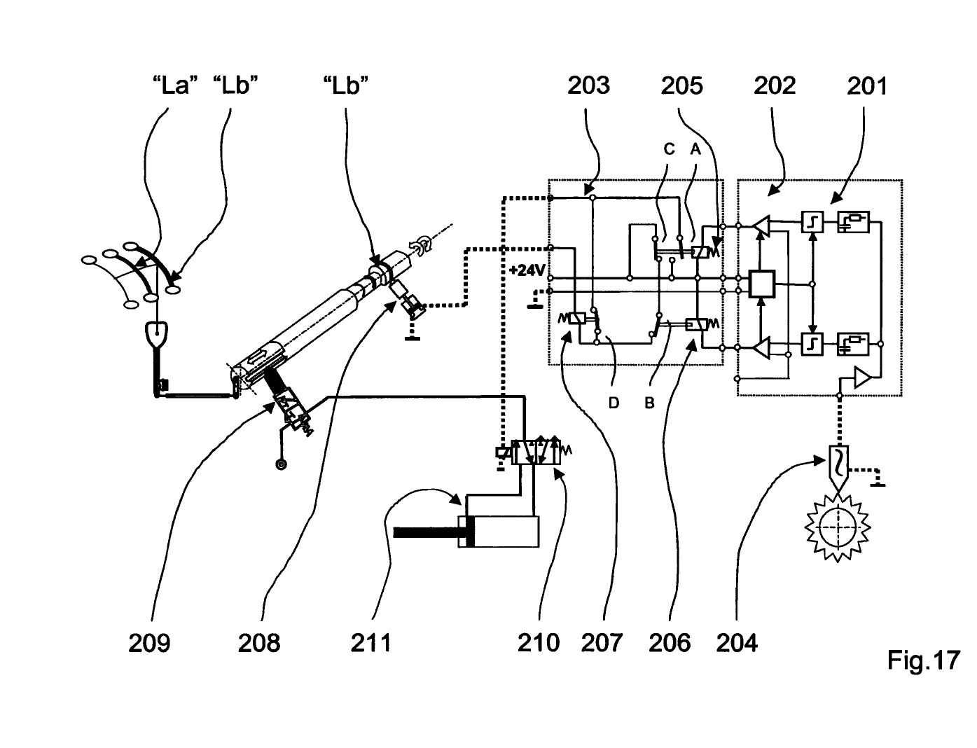

FIG. 17 shows the functional situation when the transmission is in zone C, and the gear to be shifted is in the shift gate “Lb”. Both relays 205 and 206 are energized, contact A is open, and contact B is closed, contact C is likewise closed. The relay 207 is energized, the switch of the shift gate 208 is closed, therefore the relay 207 is energized, contact D is closed, the magnetic coil of the switch valve 210 for the range group is energized, thus the “low” range stage is shifted (the pneumatic piston in the pneumatic cylinder 211 is on the left side).

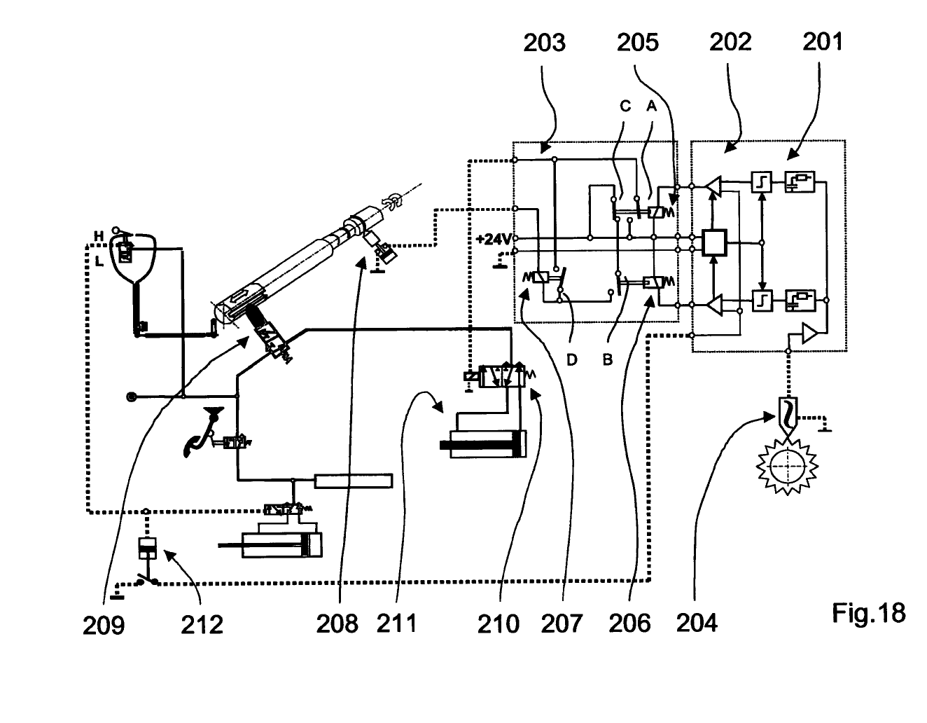

FIG. 18 shows the control device of transmissions with a splitter group according to the present invention, the preselection of the split stage being detected by an electrical pneumatic switch 212, which sends a signal to the electronic control unit 201 in order to select the frequencies of the adjustment values N1L, N2L or N1H, N2H, depending on the preselected split stage, as described above. The preselection of the (“low” or “high”) range stage corresponds to the above described method.

### REFERENCE NUMERALS

1 manual transmission
1A main transmission
1B range group
2 mechanical connection
2A shift lever
2B range group switch
2C splitter group switch
3 switch valve (range group)
4 release valve
5 pneumatic cylinder (range group)
6 gear shift shaft
7 switch valve (splitter group)
8 pneumatic cylinder (splitter group)
9 clutch pedal
10 release valve
101 manual transmission
101A main transmission
101B range group
102 mechanical connection
102A shift lever
102B range group switch
102C splitter group switch
103 switch valve (range group)
104 release valve
105 pneumatic cylinder (range group)
106 gear shift shaft
107 switch valve (splitter group)
108 pneumatic cylinder (splitter group)
109 clutch pedal
110 release valve
111 electronic control unit
111a signal line
111b signal line
111c signal line
111d signal line
112 rotational speed sensor
112 electrical switch (sensor)
114 electrical pneumatic switch (sensor)
115 compressed air reservoir
200 control device
201 electronic control device
202 first electronic module
203 second electronic module
204 rotational speed sensor
204A pulse wheel
205 electromagnetic relay
206 electromagnetic relay
207 electromagnetic relay
208 electrical switch
209 pneumatic 3-way valve
210 pneumatic 5-way valve
211 pneumatic control motor
212 switch
213 shift element
214 compressed air reservoir

1-9. (canceled)

10. A method of automatically shifting either “high” or “low” stages of a range group (101B) of a multi-step transmission, the method comprising the steps of:
detecting a transmission output rotational speed (N_{ab});
detecting a shift gate of a gear to be shifted;
defining of three output rotational speed ranges including a low range (zone A), a high range (zone B) and a middle range (zone C) for preselection of the “high” or “low” range stage;
and one of:
for at an output rotational speed in the range of zone A, preselecting of the “low” range stage independently of the gear to be shifted;
for an output rotational speed in the range of zone B, preselecting of the “high” range stage independently of the gear to be shifted;
for an output rotational speed in the range of zone C, preselecting of one of the “high” or the “low” range stage depending on the gear to be shifted with respect to the dedicated shift gate.

11. The method according to claim 10, further comprising the steps of:
defining the low range (zone A) as a range in which the output rotational speed (n_{ab}) is lower than or equal to a value N1 (n_{ab}≦N1);
defining the high range (zone B) as a range in which the output rotational speed (n_{ab}) is greater than the value N2 (n_{ab}>N1); and
defining the middle range (zone C) as a range in which the output rotational speed (n_{ab}) is greater than the value N1 and smaller than or equal to the value N2 (N1<n_{ab}≦N2).

12. The method according to claim 10, further comprising the step of, in case there is a splitter group with two split stages, modifying the positions of three output rotational speed ranges (zones A, B and C) in relation to the preselected split stage so that the three ranges (zones A_{L}, B_{L}, and C_{L}) resulting for the low split stage and three other ranges (zones A_{H}, B_{H}, and C_{H}) resulting for the high split range.

13. The method according to claim 12, further comprising the step of:
correlating a low, low range zone (A_{L}) to the operating stage in which the output rotational speed (n_{ab}) is lower than or equal to a value N1_{L} (n_{ab}≦N1_{L});
correlating a low, high range zone (A_{H}) to the operating stage in which the output rotational speed (n_{ab}) is lower than or equal to a value N1_{H} (n_{ab}≦N1_{H});
correlating a high, low range zone (B_{L}) to the operating state in which the output rotational speed (n_{ab}) is greater than the value N2_{L} (n_{ab}>N2_{L});
correlating a high, high range zone (B_{H}) to the operating state in which the output rotational speed (n_{ab}) is greater than the value N2_{H} (n_{ab}>N2_{H});
correlating an intermediate, low range zone (C_{L}) to the operating state in which the output rotational speed (n_{ab}) is greater than N1_{L} and smaller than or equal to N2_{L} (N1_{L}<n_{ab}≦N2_{L}); and
correlating an intermediate, high range (C_{H}) to the operating state in which the output rotational speed (n_{ab}) is greater than N1_{L} and smaller than or equal to N2_{L} (N1_{L}<n_{ab}≦N2_{L}).

14. A method for automatically shifting one of a high range stage and a low range stage of a range group (101B) of a multi-step transmission, the method comprising the steps of:
detecting an output rotational speed (n_{ab}) of the transmission;
detecting a shift gate of a gear to be shifted;
defining a low output rotational speed range (zone A), a high output rotational speed range (zone B) and a middle output rotational speed range (zone C); and
preselecting the low range stage, independently of the gear to be shifted, if the output rotational speed (n_{ab}) is in the low output rotational speed range (zone A);
preselecting the high range stage, independently of the gear to be shifted, if the output rotational speed (n_{ab}) is in the high output rotational speed range (zone B); and
preselecting one of the high range stage and the low range stage depending on the shift gate of the gear to be shifted, if the output rotational speed (n_{ab}) is in the middle output rotational speed range (zone C).
